(19) United States
(12) Patent Application Publication
(10) Pub. No.: US 2023/0034827 A1
(43) Pub. Date: Feb. 2, 2023

(54) CONTROL METHOD FOR ROBOT SYSTEM AND ROBOT SYSTEM

(71) Applicant: SEIKO EPSON CORPORATION, Tokyo (JP)

(72) Inventors: Tomohisa IWAZAKI, SUWA-GUN SHIMOSUWA-MACHI (JP); Yutaka ARAKAWA, SUWA-GUN HARA-MURA (JP)

(21) Appl. No.: 17/876,583

(22) Filed: Jul. 29, 2022

(30) Foreign Application Priority Data
Jul. 30, 2021 (JP) 2021-125117

(51) Int. Cl. B25J 9/16; B25J 9/12; B25J 11/00; B41M 5/00

(52) U.S. Cl. CPC B25J 9/1664; B25J 9/1697; B25J 9/1653; B25J 9/12; B25J 11/0075; B41M 5/0088

(57) ABSTRACT

A control method for a robot system including a moving stage, a tool attached to the moving stage, and a robot arm holding one of the moving stage and an object and performing predetermined work on the object using the tool, includes performing the work while moving the tool relative to the object by the moving stage with the robot arm stopped, wherein a portion having a larger curvature has a smaller range of the work than a portion having a smaller curvature of the object.

The present application is based on, and claims priority from JP Application Serial Number 2021-125117, filed Jul. 30, 2021, the disclosure of which is hereby incorporated by reference herein in its entirety.

### BACKGROUND

### 1. Technical Field

The present disclosure relates to a control method for a robot system and a robot system.

### 2. Related Art

JP-A-2-31850 discloses a robot system having a robot with a spray nozzle supported by a distal end of a robot arm via a head slide unit and painting a surface of an object by spraying paint from the spray nozzle. In the robot system, the entire object is painted by repetition of a moving step of moving the robot arm to set the spray nozzle to face an unpainted region of the object and a painting step of performing painting work of the unpainted region while moving the spray nozzle relative to the object using the head slide unit with the robot arm stopped.

However, for example, in a case where printing is performed on a curved surface using an inkjet head, when the inkjet head is moved relative to a printed surface using the slide unit, there is a problem that the separation distance between the printed surface and the inkjet head changes during the movement, and printing unevenness is caused within the printing region and an outcome of printing work is poor. This is more noticeable as the curvature of the printed region is larger.

### SUMMARY

A control method for a robot system according to an aspect of the present disclosure is a control method for a robot system including a moving stage, a tool attached to the moving stage, and a robot arm holding one of the moving stage and an object and performing predetermined work on the object using the tool, including performing the work while moving the tool relative to the object by the moving stage with the robot arm stopped, wherein a portion having a larger curvature has a smaller range of the work than a portion having a smaller curvature of the object.

A robot system according to an aspect of the present disclosure is a robot system including a moving stage, a tool attached to the moving stage, and a robot arm holding one of the moving stage and an object and performing predetermined work on the object using the tool, performing the work while moving the tool relative to the object by the moving stage with the robot arm stopped, wherein a portion having a larger curvature has a smaller range of the work than a portion having a smaller curvature of the object.

### BRIEF DESCRIPTION OF THE DRAWINGS

FIG. 1 is a perspective view showing an overall configuration of a robot system according to a first embodiment.

FIG. 2 is a plan view showing a moving stage.

FIG. 3 is a flowchart showing a printing process.

FIG. 4 shows a state in which a printing face is divided into a plurality of regions.

FIG. 5 is a diagram for explanation of a motion of an inkjet head at a printing step.

FIG. 6 is a diagram for explanation of a motion of the inkjet head at the printing step.

FIG. 7 is a diagram for explanation of a motion of the inkjet head at the printing step.

FIG. 8 is a diagram for explanation of an effect of a printing method.

FIG. 9 is a diagram for explanation of an effect of the printing method.

FIG. 10 shows a modified example of the printing method.

FIG. 11 shows a modified example of the printing method.

FIG. 12 is a diagram for explanation of a motion of the inkjet head at a printing step according to a second embodiment.

FIG. 13 is a diagram for explanation of a motion of the inkjet head at the printing step according to the second embodiment.

FIG. 14 is a diagram for explanation of an effect of a printing method.

FIG. 15 is a diagram for explanation of an effect of the printing method.

FIG. 16 is a perspective view showing an overall configuration of a robot system according to a third embodiment.

### DESCRIPTION OF EXEMPLARY EMBODIMENTS

As below, preferred embodiments of a control method for a robot system and a robot system will be explained with reference to the accompanying drawings.

### First Embodiment

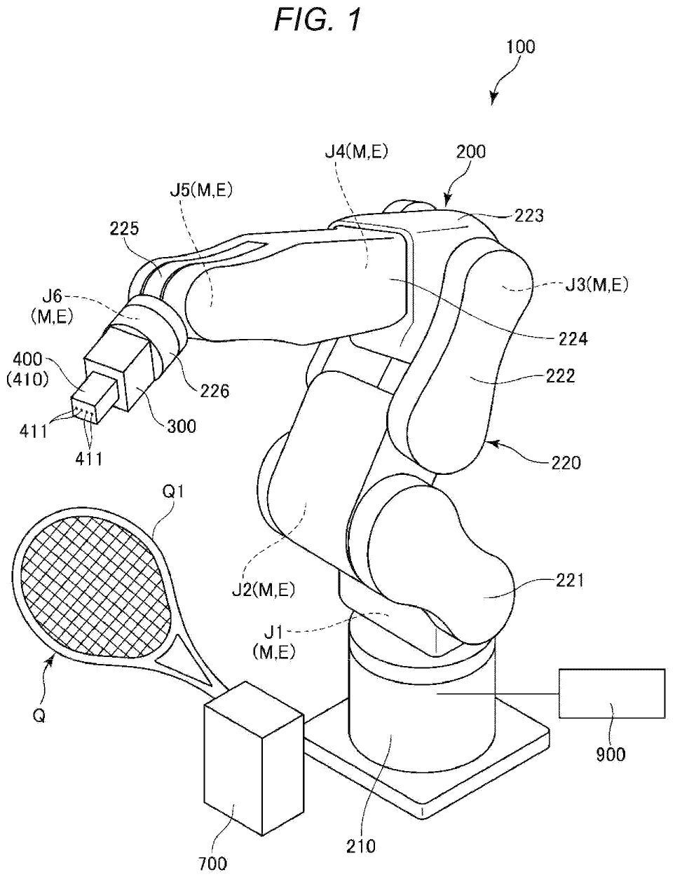

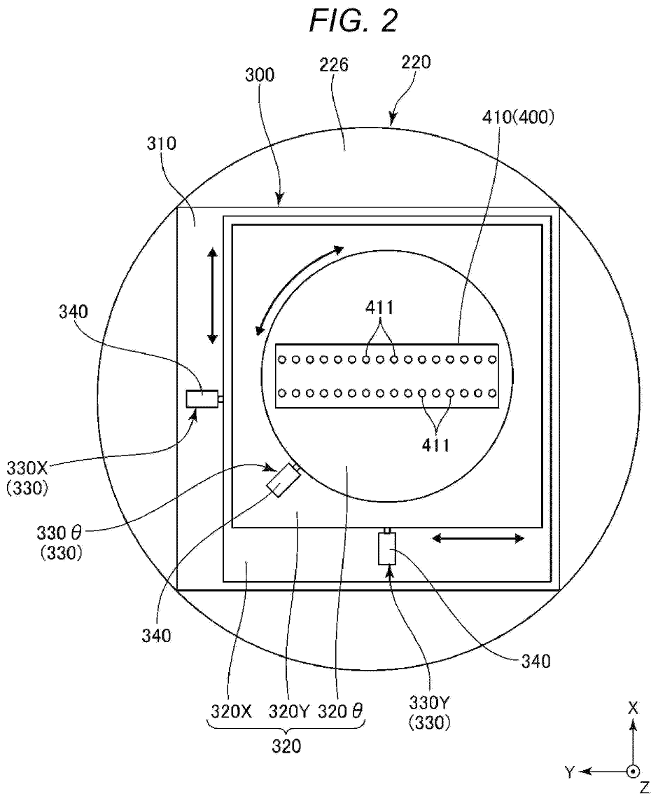

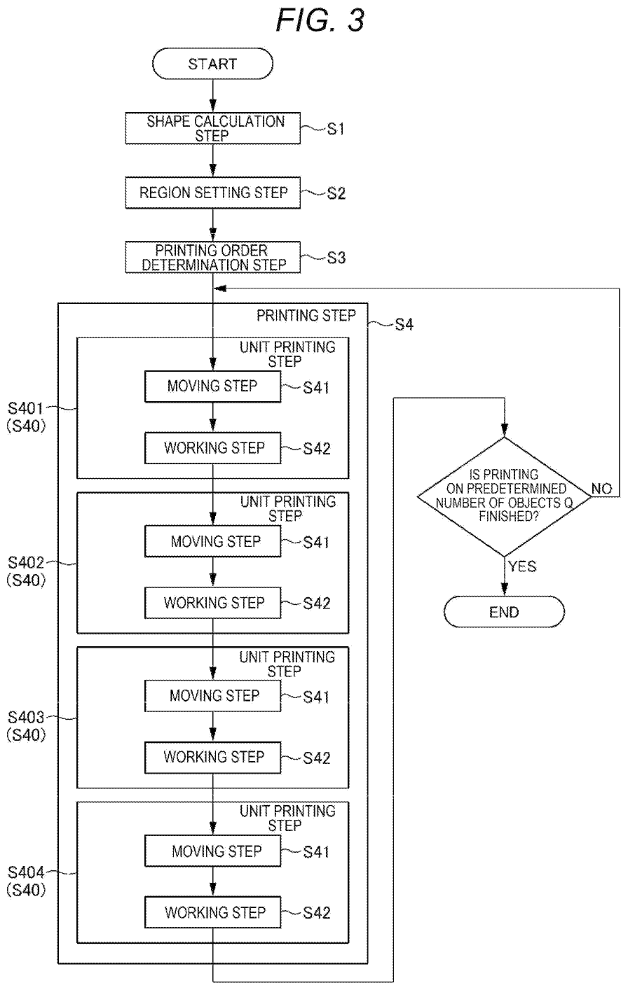

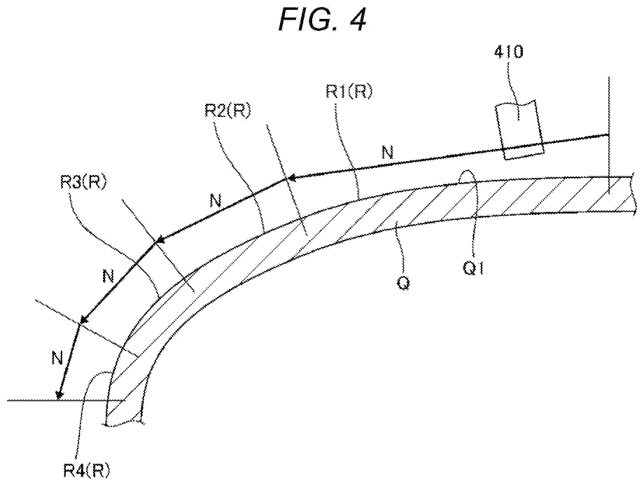

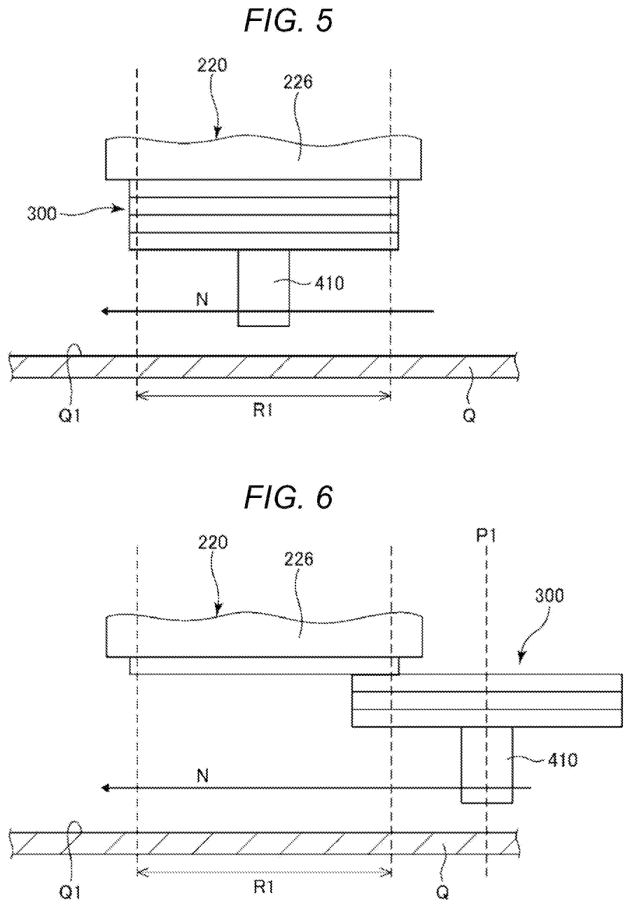

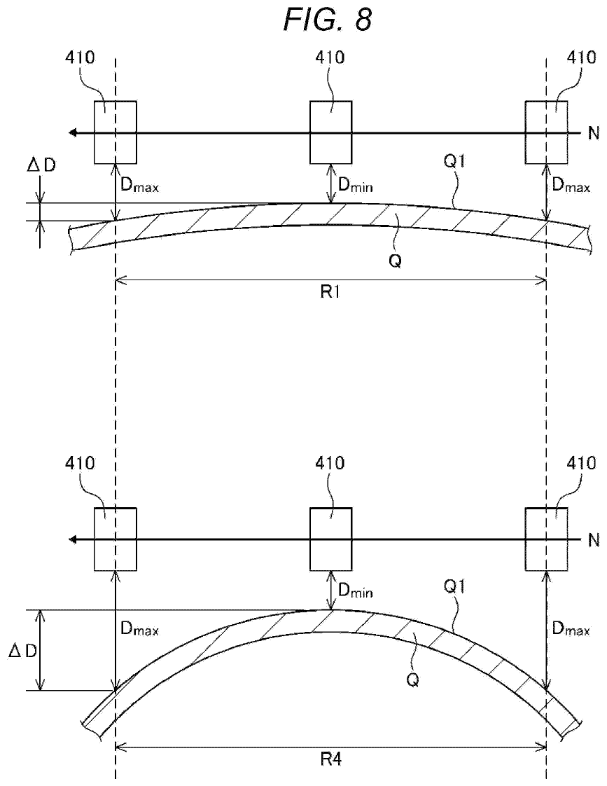

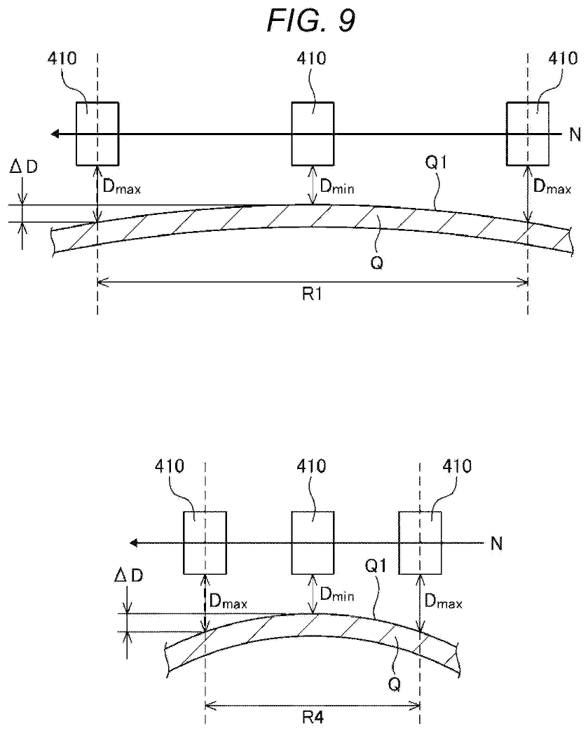

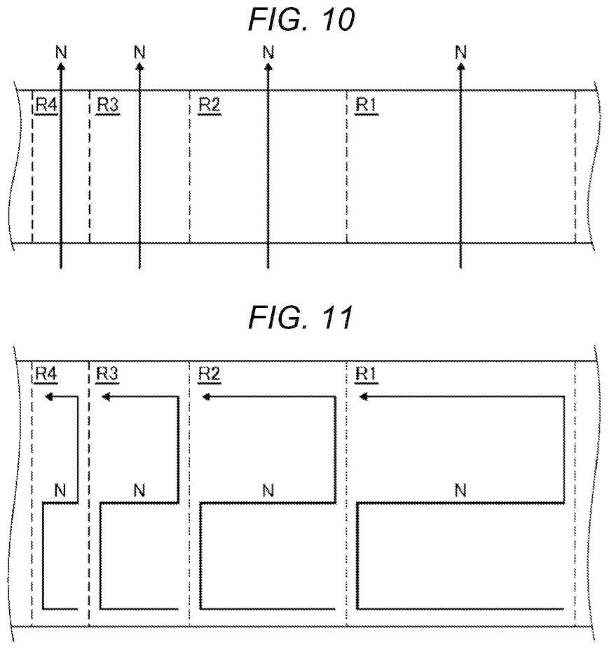

FIG. 1 is a perspective view showing an overall configuration of a robot system according to a first embodiment. FIG. 2 is a plan view showing a moving stage. FIG. 3 is a flowchart showing a printing process. FIG. 4 shows a state in which a printing face is divided into a plurality of regions. FIGS. 5 to 7 are respectively diagrams for explanation of motions of an inkjet head at a printing step. FIGS. 8 and 9 are diagrams for explanation of effects of a printing method. FIGS. 10 and 11 show modified examples of the printing method.

A robot system 100 shown in FIG. 1 has a robot 200, a robot control apparatus 900 controlling driving of the robot 200, and a fixing member 700 supporting and fixing an object Q.

The robot 200 is a six-axis robot having six drive axes. The robot 200 has a base 210 fixed to a floor, a robot arm 220 coupled to the base 210, and a tool 400 coupled to the robot arm 220 via a moving stage 300.

The robot arm 220 is a robotic arm in which a plurality of arms 221, 222, 223, 224, 225, 226 are pivotably coupled and includes six joints J1 to J6. Of the joints, the joints J2, J3, J5 are bending joints and the joints J1, J4, J6 are twisting joints. Further, motors M as drive sources and encoders E detecting rotation amounts of the motors M (pivot angles of the arms) are respectively provided in the joints J1, J2, J3, J4, J5, J6.

The tool 400 is coupled to the distal end portion of the arm 226 via the moving stage 300. That is, the moving stage 300 is held by the arm 226 and the tool 400 is attached to the moving stage 300. The tool 400 is not particularly limited, but may be appropriately set for intended work. In the embodiment, a printer head, particularly, an inkjet head 410 is used. The inkjet head 410 has an ink chamber and a vibrating plate placed on a wall surface of the ink chamber (not shown) and ink ejection holes 411 connecting to the ink chamber, and is configured so that ink within the ink chamber is ejected from the ink ejection holes 411 by vibration of the vibrating plate. Note that the configuration of the inkjet head 410 is not particularly limited. Further, the printer head is not limited to the inkjet head 410.

As shown in FIG. 2, the moving stage 300 coupling the inkjet head 410 and the robot arm 220 has a base portion 310 coupled to the arm 226, a stage 320 moving relative to the base portion 310, and a movement mechanism 330 moving the stage 320 relative to the base portion 310. With three axes orthogonal to one another as an X-axis, a Y-axis, and a Z-axis, the stage 320 has an X stage 320X movable in directions along the X-axis relative to the base portion 310, a Y stage 320Y movable in directions along the Y-axis relative to the X stage 320X, and a θ stage 320θ rotatable around the Z-axis relative to the Y stage 320Y, and the inkjet head 410 is attached to the θ stage 320θ. The X stage 320X and the Y stage 320Y are linearly guided in the X-axis directions and the Y-axis directions, respectively, by linear guides, and may smoothly move without rattle in rail directions of the linear guides.

Further, the movement mechanism 330 has an X movement mechanism 330X moving the X stage 320X in the directions along the X-axis relative to the base portion 310, a Y movement mechanism 330Y moving the Y stage 320Y in the directions along the Y-axis relative to the X stage 320X, and a θ movement mechanism 330θ rotating the θ stage 320θ around the Z-axis relative to the Y stage 320Y.

The X movement mechanism 330X, the Y movement mechanism 330Y, and the θ movement mechanism 330θ respectively have piezoelectric actuators 340 as drive sources. Thereby, the size and weight of the moving stage 300 may be reduced. Further, driving accuracy of the moving stage 300 is improved and the tool 400 is easily moved at a constant speed. Furthermore, direct driving may be performed without using reducers, and thereby, the size and weight may be further reduced. Note that the piezoelectric actuators 340 have configurations vibrating using expansion and contraction of piezoelectric elements, and the vibration is transmitted to the respective stages 320X, 320Y, 320θ to move the respective stages 320X, 320Y, 320θ. The drive sources are not particularly limited, but e.g. electromagnetic motors may be used.

The robot control apparatus 900 controls driving of the joints J1 to J6, the moving state 300, and the inkjet head 410 to control the robot 200 to perform predetermined work. The robot control apparatus 900 includes e.g. a computer having a processor (CPU) processing information, a memory communicably connected to the processor, and an external interface. Various programs that can be executed by the processor are stored in the memory, and the processor may read and execute the various programs etc. stored in the memory.

As above, the configuration of the robot system 100 is explained. The robot control apparatus 900 controls the respective units of the system, and thereby, for example, as shown in FIG. 1, the robot system 100 may perform work to print a desired pattern on a printing face Q1 provided on a surface of the object Q having a three-dimensional shape using the inkjet head 410 (hereinafter, also simply referred to as “printing work”). Note that, as will be described later, the printing work is performed while moving the inkjet head 410 in a direction shown by an arrow N with respect to each of four regions R1, R2, R3, R4 (see FIG. 4). As below, a control method for performing the work will be explained.

As shown in FIG. 3, the printing work includes a shape calculation step S1 of calculating a shape of the object Q, specifically, a shape of the printing face Q1, a region setting step S2 of dividing the printing face Q1 into a plurality of regions R based on the shape of the printing face Q1, a printing order determination step S3 of determining a printing order of the respective regions R, and a printing step S4 of performing printing using the inkjet head 410 with respect to each region R according to the determined printing order. Further, the printing step S4 includes a unit printing step S40 including a moving step S41 of driving the robot arm 220 to set the inkjet head 410 to face the region R and a working step S42 of performing printing in the region R using the inkjet head 410 while moving the inkjet head 410 relative to the printing face Q1 by the moving stage 300 with the robot arm 220 stopped, and the unit printing step S40 is repeatedly performed with respect to each region R according to the order determined at the printing order determination step S3. As below, the respective steps will be sequentially explained.

### Shape Calculation Step S1

At the shape calculation step S1, the shape of the object Q, specifically, the shape of the printing face Q1 is calculated. In the embodiment, CAD data as 3D data of the object Q is acquired in advance and the shape of the printing face Q1 is calculated based on the CAD data. According to the method, the shape of the printing face Q1 may be calculated more simply and accurately.

Note that the method of calculating the shape of the printing face Q1 is not particularly limited. For example, a 3D camera or a plurality of 2D cameras may be added to the robot system 100, and the shape of the printing face Q1 may be calculated based on imaging data of the object Q acquired by the added camera. According to the method, the shape of the printing face Q1 may also be calculated more simply and accurately. In addition, the method includes a method of calculating the shape of the printing face Q1 using a depth sensor and a method of calculating the shape of the printing face Q1 by the phase shift method using a projector projecting a striped light pattern on the printing face Q1 and a camera imaging the printing face Q1 on which the light pattern is radiated.

### Region Setting Step S2

At the region setting step S2, the printing face Q1 is divided into a plurality of regions R based on the shape of the printing face Q1 calculated at the shape calculation step S1. The portions having larger curvatures of the printing face Q1 are divided into the regions R having smaller areas. For example, in the example shown in FIG. 4, the printing face Q1 is divided into the four regions R1, R2, R3, R4. The magnitude relationship among these four regions R1, R2, R3, R4 in curvature is region R1<region R2<region R3<region 4, and the magnitude relationship in area is region R1>region R2>region R3>region 4. As described above, the printing face Q1 is divided into the plurality of regions R so that the portions having larger curvatures may have the smaller areas (ranges), and thereby, as will be described later, high quality printing may be accurately performed on the printing face Q1. Note that “curvature” refers to e.g. an average curvature or the maximum curvature of the region R. Further, “area” refers to e.g. a length of each region R along the arrow N.

In the embodiment, as the curvature is larger, the area of the region R is continuously made smaller, however, the method of determining the area of the region R is not particularly limited. For example, the area of the region R may be made smaller in stages in such a manner that, when A1<curvature≤A2, the area of the region R is set to C1, when A2<curvature≤A3, the area of the region R is set to C2 (<C1), and, when A3<curvature≤A4, the area of the region R is set to C3 (<C2).

### Printing Order Determination Step S3

At the printing order determination step S3, the printing order of the four regions R1, R2, R3, R4 at the printing step S4 is determined. In the embodiment, the regions R1, R2, R3, R4 are sequentially printed in the order of the arrangement. Thereby, unnecessary motion of the robot 200 during the printing work is reduced and the printing step S4 may be efficiently performed. Accordingly, the takt time becomes shorter and the productivity is improved. Note that the printing order is not particularly limited to the order of arrangement, but may be e.g. the descending order of curvature, the ascending order of curvature, or the like.

Further, at the printing order determination step S3, activation conditions of the robot 200 in the respective regions R1, R2, R3, R4 are determined. The activation conditions are not particularly limited to, but include e.g. the attitudes of the robot arm 220 in the respective regions R1, R2, R3, R4, accelerations, decelerations, and maximum velocities of the inkjet head 410, and output conditions of ink ejection amounts, ink ejection intervals, etc. of the inkjet head 410.

### Printing Step S4

At the printing step S4, printing is performed with respect to each of the regions R1, R2, R3, R4 according to the order determined at the printing order determination step S3 using the inkjet head 410. Specifically, the printing step S4 includes a unit printing step S401 of printing in the region R1, a unit printing step S402 of printing in the region R2, a unit printing step S403 of printing in the region R3, and a unit printing step S404 of printing in the region R4.

As described above, the respective unit printing steps S401 to S404 include the moving steps S41 of driving the robot arm 220 to set the inkjet head 410 to face the regions R1, R2, R3, R4, and working steps S42 of performing printing in the regions R1, R2, R3, R4 using the inkjet head 410 while moving the inkjet head 410 relative to the printing face Q1 by the moving stage 300 with the robot arm 220 stopped.

Note that the unit printing steps S402, S403, S404 are repetition of the unit printing step S401 and, as below, only the unit printing step S401 will be explained with reference to FIGS. 5 to 7 and the explanation of the unit printing steps S402, S403, S404 will be omitted. In FIGS. 5 to 7, for convenience of explanation, the printing face Q1 having the curved shape is shown as a planar surface.

### Unit Printing Step S401

First, as the moving step S41, as shown in FIG. 5, the robot arm 220 is driven to set the inkjet head 410 to face the region R1. The separation distance between the inkjet head 410 and the region R1 is set within a proper gap preset for the inkjet head 410. In this state, the movable range of the inkjet head 410 by driving of the moving stage 300 overlaps with the entire region R1.

Then, the working step S42 is performed with the robot arm 220 stopped. At the working step S42, first, as shown in FIG. 6, the moving stage 300 is driven to move the inkjet head 410 to a movement start position P1. The movement start position P1 is located outside of the region R1 closer to the base end side of the arrow N than the region R1.

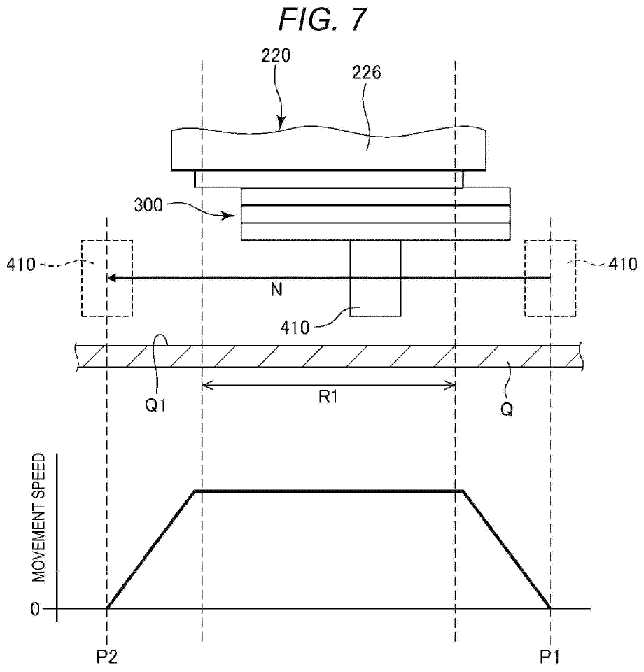

Then, as shown in FIG. 7, while the moving stage 300 is driven to move the inkjet head 410 from the movement start position P1 to a movement end position P2 along the arrow N, printing in the region R1 is performed by ejection of the ink from the inkjet head 410 with predetermined timing. Here, the movement end position P2 is located outside of the region R1 closer to the tip end side of the arrow N than the region R1. As described above, with the robot arm 220 stopped, without influences by vibration due to motors and reducers driving in the joints of the robot arm 220 and variations in trajectory, when the moving stage 300 is driven, accurate printing may be performed along the movement direction because the inkjet head slides along the linear guides of the moving stage 300.

Note that, as seen from FIG. 7, the inkjet head 410 moves at a constant speed within the region R1 and printing in the region R1 is performed during the movement at the constant speed. In other words, printing is not performed when the inkjet head 410 moves with an acceleration or a deceleration. As described above, printing is performed when the inkjet head 410 moves at the constant speed, and thereby, control of ink ejection timing of the inkjet head 410 may be easier and printing in the region R1 may be performed more accurately.

Here, as described above, the movement start position P1 is set outside of the region R1 to end the movement with the acceleration before the inkjet head 410 enters the region R1 and shift to the movement at the constant speed. Similarly, the movement end position P2 is set outside of the region R1 to start the movement with the deceleration after the inkjet head 410 exits the region R1 and stop the head. Thereby, the inkjet head 410 may be moved at the constant speed in the entire region R1 and the above described effect may be exerted more reliably. That is, the movement start position P1 is set in a position sufficient for movement of the inkjet head 410 at the constant speed before entry in the region R1 and the movement end position P2 is set in a position sufficient for deceleration and stoppage of the inkjet head 410 after exit from the region R1.

Subsequent to the unit printing step S401, the unit printing steps S402, S403, S404 are performed in the same manner, and thereby, printing on the entire printing face Q1 ends. As shown in FIG. 3, when the printing on the printing face Q1 ends, whether or not printing work on a predetermined number of objects Q is finished is determined, and, when the printing work is finished, the work by the robot system 100 ends. On the other hand, when the printing work is not finished, a new object Q is refixed to the fixing member 700 and printing work is performed from the printing step S4.

Next, effects of the printing method will be explained with reference to FIGS. 8 and 9. FIG. 8 shows the region R1 and the region R4 having different curvatures from each other. When the inkjet head 410 moves along the arrow N, the separation distance when the inkjet head 410 is closest to the printing face Q1 is the minimum separation distance Dmin, the separation distance when the inkjet head 410 is farthest from the printing face Q1 is the maximum separation distance Dmax, and a difference between Dmin and Dmax is a distance difference ΔD. As shown in the same drawing, if the region R1 and the region R4 have the same area, the region R4 having the larger curvature has the larger maximum separation distance Dmax and the larger distance difference ΔD than the region R1 having the smaller curvature. When the maximum separation distance Dmax becomes larger such that the separation distance between the inkjet head 410 and the printing face Q1 exceeds the proper gap, the attachment range of one droplet of ink may be wider and the attachment location may deviate, and the printing quality may be lower. Further, when the distance difference ΔD is larger, unevenness of printing quality is easily caused within the region R4.

Accordingly, in the embodiment, as shown in FIG. 9, the area of the region R4 having the larger curvature is set to be smaller than the area of the region R1 having the smaller curvature, and thereby, the maximum separation distance Dmax and the difference ΔD are set not to be excessively large. Further, the separation distance between the inkjet head 410 and the printing face Q1 may be set within the proper gap, preferably nearly constant. Thereby, the above described problems are hard to occur and printing in the region R4 may be accurately performed.

Particularly, the respective regions R1, R2, R3, R4 are set so that the minimum separation distances Dmin, the maximum separation distances Dmax, and the distance differences ΔD may be nearly equal to one another, and thereby, the printing on the printing face Q1 may be uniformly and accurately performed. Note that the minimum separation distances Dmin, the maximum separation distances Dmax, and the distance differences ΔD are respectively not particularly limited, but may be appropriately set depending on the characteristics of the inkjet head 410, the movement speed of the inkjet head 410, or the like.

As above, the robot system 100 of the embodiment is explained. As described above, the control method for the robot system 100 is a control method for the robot system 100 including the moving stage 300, the tool 400 attached to the moving stage 300, and the robot arm 220 holding one of the moving stage 300 and the object Q and performing predetermined work on the object Q using the tool 400, including performing work while moving the tool 400 relative to the object Q by the moving stage 300 with the robot arm 220 stopped, wherein the portion having the larger curvature has the smaller work range, i.e. the smaller region R than the portion having the smaller curvature of the object Q. Thereby, relative movement of the tool 400 and the object Q may be accurately performed and the separation distance between the tool 400 and the object Q may be harder to be varied, and work on the object Q may be uniformly and accurately performed.

As described above, the robot arm 220 holds the moving stage 300. Thereby, work on the object Q is easily performed. Further, as described above, the moving stage 300 holds the tool 400. Thereby, work on the object Q is easily performed.

As described above, in the control method for the robot system 100, the moving stage 300 has the piezoelectric actuators 340 as the drive sources. Thereby, the size and weight of the moving stage 300 may be reduced. Further, driving accuracy of the moving stage 300 is improved and the tool 400 is easily moved at a constant speed.

As described above, in the control method for the robot system 100, the tool 400 is the inkjet head 410 as the printer head. Thereby, printing work on the object Q may be performed. Accordingly, the highly convenient robot system 100 is obtained.

As described above, in the control method for the robot system 100, the shape of the object Q is calculated based on the CAD data of the object Q.

As described above, in the control method for the robot system 100, the shape of the object Q may be calculated based on imaging data obtained by imaging of the object Q. Thereby, the shape of the object Q may be calculated more simply and accurately.

As described above, in the control method for the robot system 100, work is not performed while the tool 400 is accelerated or decelerated by driving of the moving stage 300. Thereby, driving control of the tool is easier and work accuracy is improved.

As described above, in the control method for the robot system 100, the movement start position P1 of the tool 400 during work is located outside of the region R1 outside of the work range. Thereby, the movement with the acceleration may be ended before the inkjet head 410 enters the region R1 and shifted to the movement at the constant speed. Accordingly, the accuracy of the work on the region R1 is improved.

As described above, the robot system 100 is the robot system 100 including the moving stage 300, the tool 400 attached to the moving stage 300, and the robot arm 220 holding one of the moving stage 300 and the object Q and performing predetermined work on the object Q using the tool 400, performing work while moving the tool 400 relative to the object Q by the moving stage 300 with the robot arm 220 stopped, wherein the portion having the larger curvature has the smaller work range, i.e. the smaller region R than the portion having the smaller curvature of the object Q. Thereby, the separation distance between the tool 400 and the object Q may be harder to be varied, and work on the object Q may be uniformly and accurately performed.

As above, the robot system 100 is explained, however, the robot system 100 is not particularly limited. For example, in the embodiment, the arrow N as the movement direction of the inkjet head 410 at the printing step S4 is along the arrangement direction of the regions R1, R2, R3, R4, however, for example, as shown in FIG. 10, the movement direction of the inkjet head 410 in the respective regions R1, R2, R3, R4 may be orthogonal (cross) the arrangement direction of the regions R1, R2, R3, R4. Or, as shown in FIG. 11, the movement direction of the inkjet head 410 in the respective regions R1, R2, R3, R4 may two-dimensionally meander.

### Second Embodiment

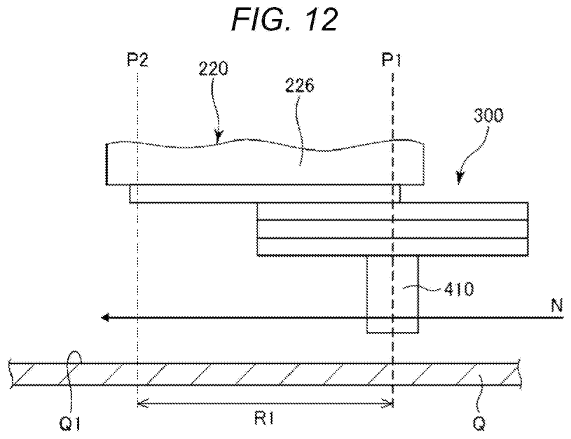

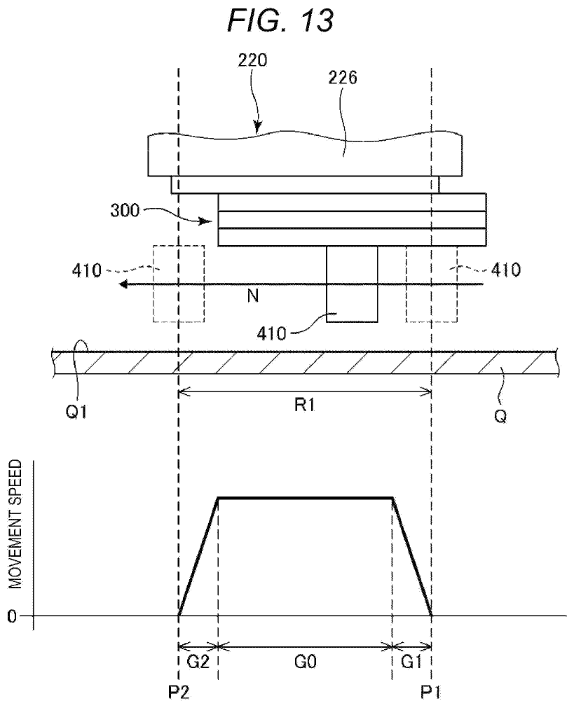

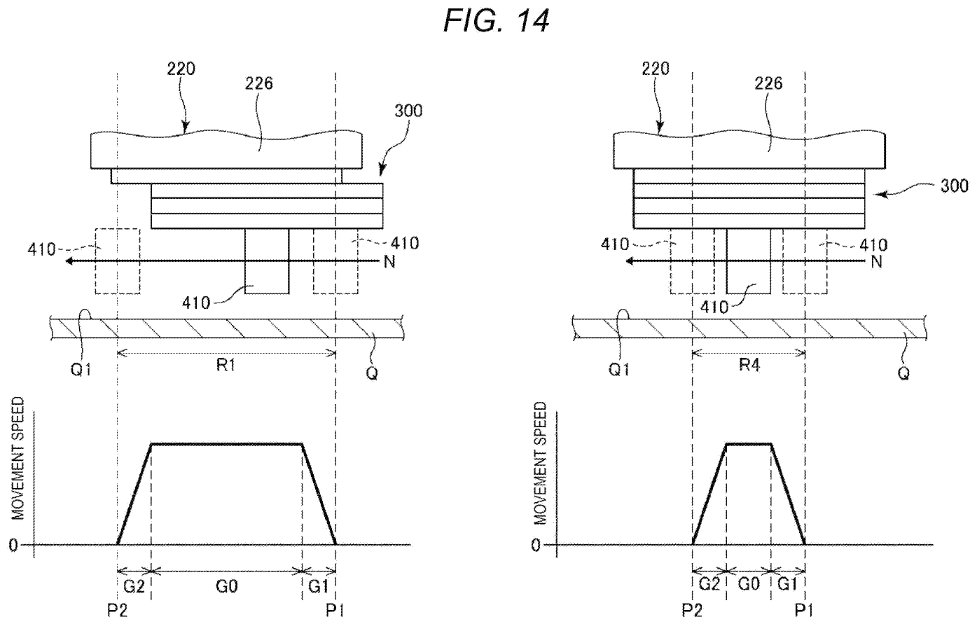

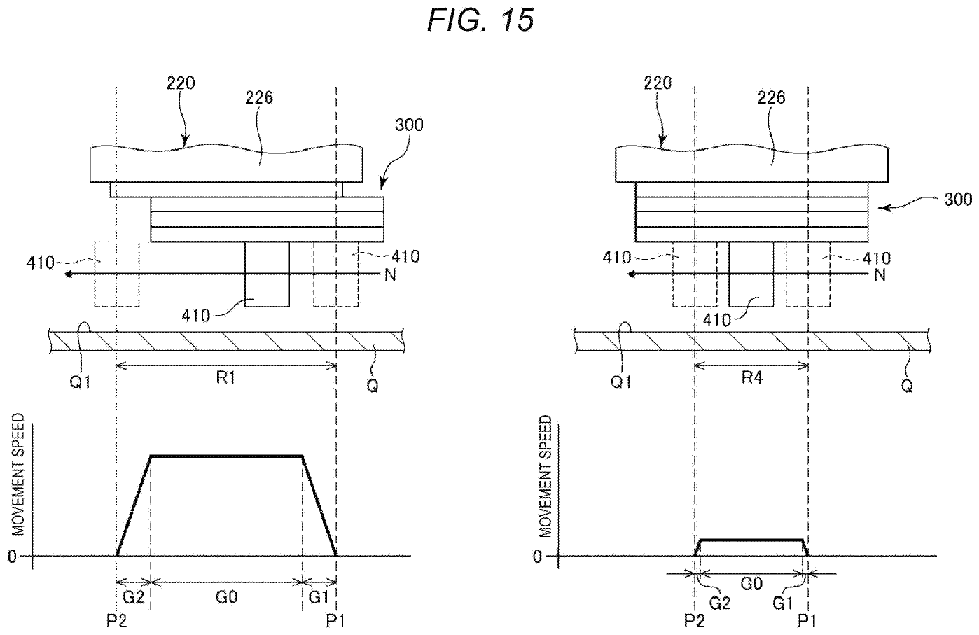

FIGS. 12 and 13 are respectively diagrams for explanation motions of the inkjet head at a printing step according to a second embodiment. FIGS. 14 and 15 are respectively diagrams for explanation of effects of a printing method. In FIGS. 12 to 15, for convenience of explanation, the printing face Q1 having the curved shape is shown as a planar surface.

A robot system 100 of the embodiment is the same as the robot system 100 of the above described first embodiment except that the printing step S4 is different. Accordingly, in the following description, the embodiment will be explained with a focus on the differences from the above described first embodiment and the explanation of the same items will be omitted. Further, in the respective drawings in the embodiment, the same configurations as those of the above described embodiment have the same signs.

### Unit Printing Step S401

First, like the above described first embodiment, as the moving step S41, the robot arm 220 is driven to set the inkjet head 410 to face the region R1. Then, the working step S42 is performed with the robot arm 220 stopped. At the working step S42, first, as shown in FIG. 12, the moving stage 300 is driven to move the inkjet head 410 to the movement start position P1. Here, the movement start position P1 is set at an end of the region R1 unlike the above described first embodiment.

Then, as shown in FIG. 13, while the moving stage 300 is driven to move the inkjet head 410 from the movement start position P1 to the movement end position P2 along the arrow N, printing in the region R1 is performed by ejection of the ink from the inkjet head 410 with predetermined timing. Here, the movement end position P2 is set at an end of the region R1 unlike the above described first embodiment.

According to the method, for example, in comparison to the above described first embodiment, the movement distance of the inkjet head 410 when printing in the region R1 is performed, i.e., the separation distance between the movement start position P1 and the movement end position P2 may be shortened. Accordingly, the time taken for the printing step S4 may be made shorter.

Note that, as shown in FIG. 13, in the embodiment, unlike the above described first embodiment, an acceleration region G1 and a deceleration region G2 of the inkjet head 410 are located within the region R1. Accordingly, even in acceleration and deceleration of the inkjet head 410, it is necessary to perform printing by ejection of the ink from the inkjet head 410. In this regard, it is preferable to control the time to eject the ink from the inkjet head 410 according to the movement speed of the inkjet head 410 so that the pitches of ink dots may be equal. Specifically, it is preferable to set the time intervals of ejection of the ink from the inkjet head 410 to be shorter as the movement speed of the inkjet head 410 is higher. Thereby, printing in the region R1 may be uniformly and accurately performed.

As above, the unit printing step S401 is explained, and the unit printing steps S402, S403, S404 are the same. Note that, when the movement speeds of the movement at the constant speeds of the inkjet head 410 at the unit printing steps S401, S402, S403, S404 are V1, V2, V3, V4, respectively, V1>V2>V3>V4. That is, the movement speed of the movement at the constant speed of the inkjet head 410 is lower as the region R has the larger curvature.

The reason for this is explained by comparison between the regions R1, R4 in an understandable manner. As shown in FIG. 14, in the region R1 having the smaller curvature, the area is larger and, even when the movement speed of the movement at the constant speed of the inkjet head 410 is increased, a constant-speed movement region G0 may be sufficiently secured. On the other hand, in the region R4 having the larger curvature, the area is smaller and, when the movement speed of the movement at the constant speed of the inkjet head 410 is increased equally to that in the region R1, the acceleration region G1 and the deceleration region G2 become larger and the constant-speed movement region G0 may be insufficiently secured.

Accordingly, in the embodiment, as shown in FIG. 15, the movement speed of the movement at the constant speed of the inkjet head 410 in the region R4 is set to be lower, and thereby, the acceleration region G1 and the deceleration region G2 are made smaller and the constant-speed movement region G0 is sufficiently secured in the region R4. The control of the ink ejection timing of the inkjet head 410 is easier and the printing has higher quality in the constant-speed movement than in the acceleration. Therefore, as described above, the movement speed of the movement at the constant speed of the inkjet head 410 is set to be lower as the region R has the larger curvature so that the constant-speed movement regions may be sufficiently secured in the respective regions R1, R2, R3, R4.

Note that, if the movement speeds of the movement at the constant speed of the inkjet head 410 are uniformly set to be lower in all regions R1, R2, R3, R4, the constant-speed movement regions G0 may be secured to be larger in the respective regions R1, R2, R3, R4, however, the time taken for the printing step S4 is longer and the productivity is lower. Accordingly, in the embodiment, as described above, the movement speed of the movement at the constant speed of the inkjet head 410 is set to be lower as the region R has the larger curvature, and thereby, work efficiency and work accuracy are balanced.

As described above, in the control method for the robot system 100 of the embodiment, the movement speed of the tool 400 is lower in the portion having the larger curvature than in the portion having the smaller curvature of the object Q. Thereby, efficiency and accuracy of work may be balanced.

According to the second embodiment, the same effects as those of the above described first embodiment may be exerted.

### Third Embodiment

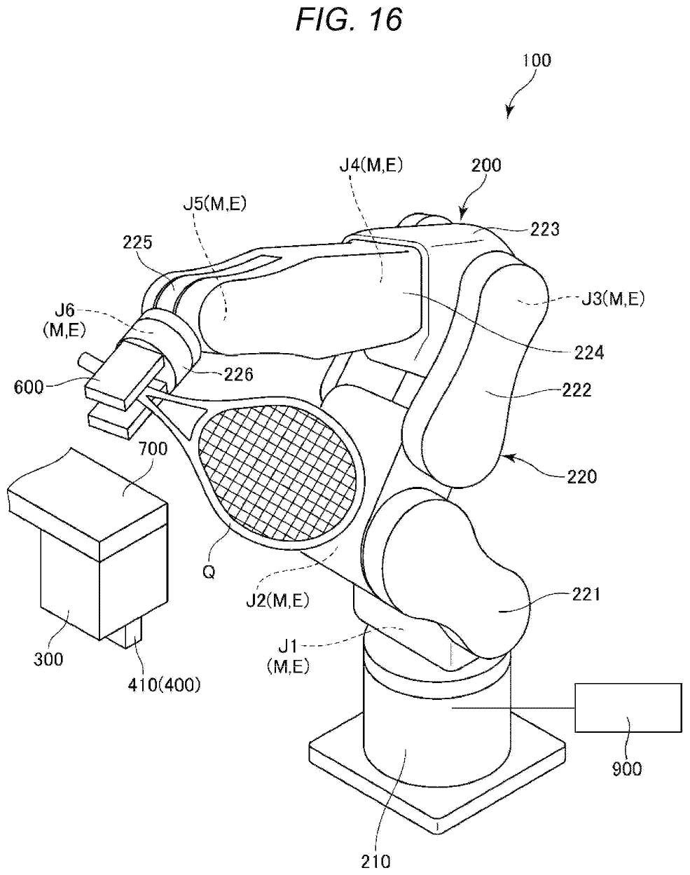

FIG. 16 is a perspective view showing an overall configuration of a robot system according to a third embodiment.

A robot system 100 of the embodiment is the same as the robot system 100 of the above described first embodiment except that the placement of the moving stage 300 and the tool 400 is different. Accordingly, in the following description, the embodiment will be explained with a focus on the differences from the above described first embodiment and the explanation of the same items will be omitted. Further, in the respective drawings in the embodiment, the same configurations as those of the above described embodiment have the same signs.

As shown in FIG. 16, a hand 600 is placed in the distal end portion of the robot arm 220, i.e., the arm 226, and the hand 600 grips the object Q in work. That is, the robot arm 220 holds the object Q via the hand 600. On the other hand, the moving stage 300 is fixed to the fixing member 700 apart from the robot arm 220 and the inkjet head 410 is placed on the moving stage 300.

According to the third embodiment, the same effects as those of the above described first embodiment may be exerted. Note that, in addition, for example, the hand 600 may be coupled to the arm 226 via the moving stage 300 and the inkjet head 410 may be fixed to the fixing member 700 apart from the robot arm 220. Further, the inkjet head 410 may be coupled to the arm 226 and the hand 600 may be coupled to the fixing member 700 via the moving stage 300 apart from the robot arm 220.

As above, the control method for the robot system and the robot system according to the present disclosure are explained based on the illustrated embodiments, however, the present disclosure is not limited to those. The configurations of the respective parts may be replaced by arbitrary configurations having the same functions. Further, any other configuration may be added to the present disclosure. Furthermore, the respective embodiments may be appropriately combined.

Moreover, the tool 400 is not limited to the inkjet head 410, but includes a tool for laser processing, a tool for soldering work, a tool for welding, and a tool for work performed in synchronization with a movement trajectory of a tool.

What is claimed is:

1. A control method for a robot system including a moving stage, a tool attached to the moving stage, and a robot arm holding one of the moving stage and an object and performing predetermined work on the object using the tool, comprising performing the work while moving the tool relative to the object by the moving stage with the robot arm stopped, wherein
a portion having a larger curvature has a smaller range of the work than a portion having a smaller curvature of the object.

2. The control method for a robot system according to claim 1, wherein
the robot arm holds the moving stage.

3. The control method for a robot system according to claim 2, wherein
the moving stage holds the tool.

4. The control method for a robot system according to claim 1, wherein
the moving stage has a piezoelectric actuator as a drive source.

5. The control method for a robot system according to claim 1, wherein
the tool is a printer head.

6. The control method for a robot system according to claim 1, wherein
a shape of the object is calculated based on CAD data of the object.

7. The control method for a robot system according to claim 1, wherein
a shape of the object is calculated based on imaging data obtained by imaging of the object.

8. The control method for a robot system according to claim 1, wherein
while the tool is accelerated or decelerated by driving of the moving stage, the work is not performed.

9. The control method for a robot system according to claim 1, wherein
a movement start position of the tool in the work is located outside of the range of the work.

10. The control method for a robot system according to claim 1, wherein
the portion having the larger curvature has a lower movement speed of the tool than the portion having the smaller curvature of the object.

11. A robot system including a moving stage, a tool attached to the moving stage, and a robot arm holding one of the moving stage and an object and performing predetermined work on the object using the tool,
performing the work while moving the tool relative to the object by the moving stage with the robot arm stopped, wherein
a portion having a larger curvature has a smaller range of the work than a portion having a smaller curvature of the object.
